(19) United States
(12) Patent Application Publication
(10) Pub. No.: US 2008/0022351 A1
(43) Pub. Date: Jan. 24, 2008

(54) Streaming method and apparatus

(76) Inventors: Martin Nohr, Medicine Hat (CA); Thomas G. Serface, Los Gatos, CA (US); David C. Burns, Eden Prairie, MN (US); Kevin L. Stagg, Savage, MN (US)

Correspondence Address: Leffert Jay & Polglaze, P.A., P. O. Box 581009, Minneapolis, MN, 55458-1009, US

(21) Appl. No.: 11/481,561

(22) Filed: Jul. 6, 2006

(51) Int. Cl. H04N 7/16; H04N 7/173

(52) U.S. Cl. 725/142; 725/134; 725/153

(57) ABSTRACT

A method and apparatus for streaming of data from a remote computer to a recordable media production system is described that utilizes a client computer based application that reduces or eliminates the need for caching of data at the production system, as well as increases security and reliability. This is accomplished in the various embodiments with a client computer application that is run at the user level reducing system complexity and the need for system administrator involvement and oversight. The application pushes data to a production system “on the fly” without requiring a cache or extra disk space.

### FIELD

The present invention relates generally to streaming content and in particular the present invention relates to production of streaming content and remote recording.

### BACKGROUND

Storage capacity for computer and electronic readable media continues to increase at rapid rates. Just a few years ago, removable media such as floppy disks were limited to 1.44 Megabytes. Now, recordable media such as DVD and dual layer DVD allow storage of upwards of 9 Gigabytes (GB), and newer technology such as Blu-Ray DVDs allow storage of 27 GB or higher.

Still further, the increased availability of broadband connections to the Internet has increased greatly the amount of data that is transferred between computers and on networks. However, as the amount of data that is moved increases, and the storage capacity of media increases, the demand for viable methods and systems to transfer and manage large amounts of data also increases.

In a production setting, that is in a setting in which data stored on one computer is transferred as an image to a recordable media production system capable of large volume production to be written in final form to recordable media, streaming and other forms of file transfer provide methods of transferring a recordable media image without overtaxing the limits of the production system or its controller. This is typically done by locally caching the data on the production system that is transferred or streamed from the remote computer. The cache is a dedicated memory, hard drive, or the like, that serves as an I/O buffer so that the production device or end recorder has sufficient data locally stored to be able to assemble and record the image at its given speed of recording. As storage capacities for recordable media continue to increase, the amount of data required to be cached locally on the production system increases as well.

In prior art systems and methods, a partial or full image of a project to be recorded or produced at a production server is generated at a remote computer. An “image” is defined herein to be an image of the desired file system (such as a CD-ROM disc, a DVD disc, or a hard drive disk) or format (such as an Audio CD disc) and its associated data to be written to the recordable media. A partial image typically contains a file system or format for the disc project, and a list of files including their sizes and locations at the remote computer, whereas a full image is a fully assembled file system or format image and contains all data and files to be recorded on the recordable media. The image is sent to the production server, and the full or partial disc image information is cached locally at the production system for recording. Using the full or partial disc image and the associated information, such as the list of included files, sizes and locations, the production system then assembles a recordable image that it writes to the recordable media via a recorder. This type of system typically requires that the production server have system level access to the data at the remote computer, and can pull that data and process/assemble the image, placing it in the cache for recording. This limits the speed and reliability of recording because it relies on the speed and size of the cache and generally requires that the cache size has to be increased with the size of the recordable media being utilized, especially if the production jobs are very large, or the production jobs include jobs for multiple recorders in a single production system.

The details of file transfer, mountable disk shares, and streaming on demand, with protocols such as TCP/IP are known in the art, and are not described in greater detail herein.

For the reasons stated above, and for other reasons stated below which will become apparent to those skilled in the art upon reading and understanding the present specification, there is a need in the art for better streaming of data to a production system.

### BRIEF DESCRIPTION OF DRAWINGS

FIG. 1 is a system according to an embodiment of the invention.

FIG. 2 is a system according to another embodiment of the invention.

FIG. 3 is a message flow protocol of transactions between a producer and remote computer according to an embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims, along with the full scope of equivalents to which such claims are entitled.

The methods and apparatus of the present invention allow for the streaming of data from a remote computer to a production system or server using a client computer based application that reduces or eliminates the need for caching of data at the production system, as well as increases security and reliability. This is accomplished in the various embodiments with a client computer application that is run at the user level reducing system complexity and the need for system administrator involvement and oversight. The application pushes data to a production system “on the fly” as it is needed, allowing the production system to operate without requiring a local cache or extra disk space. It is noted that embodiments of the present invention are adapted to scale as recordable media sizes increase. It is also noted that “recordable media” is defined herein to include media of a fixed size, including magnetic media (such as, but not limited to, floppy disks, tapes and hard drive disks), optical media (such as, but not limited to, CD-ROMs, DVDs, Blue-Ray DVDs, Magneto-Optical (MO) disc, and Holographic), and solid-state media (such as, but not limited to, Flash memory devices and PROM memory devices).

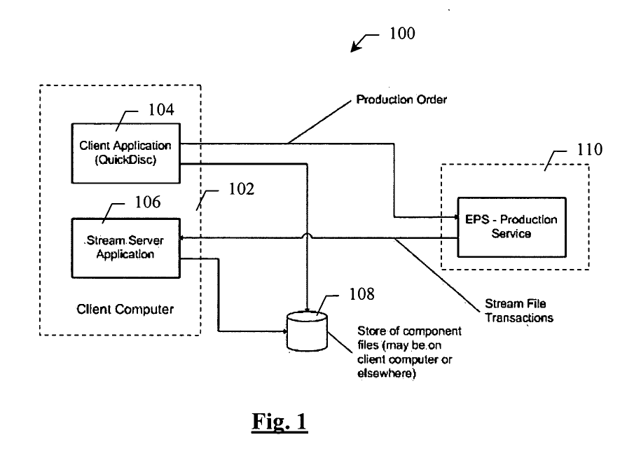

Referring now to FIG. 1, a system according to one embodiment of the invention is shown. The system 100 includes a client computer 102 having a client application 104 and a stream server application 106. A store of component files 108 for the image (such as a full image, a partial image, ISO image, UDF image, hybrid image, multi-session image, RAW image, audio format image, or the proprietary PowerImage described below) may be on the client computer 102 or stored at a separate location. A remote production server 110 is connectable to the client computer 102 via a wired or wireless connection. The type of connection may be varied without departing from the scope of the invention. In one embodiment, the client application 104 has full access to the files on the client computer, or to the store of component files 108. These files are used to create a disc image for the appropriate recordable media (floppy disk, optical media, hard drive disk, etc.) to be sent to the production server 110. When a user wishes to create a production request, the user starts up the client application 104 to generate the image to be recorded. Once that is complete, the stream server application 106 is started. It is noted that even though the present description relates to the stream server 106, client application 104, and/or production system 110 executing in a Microsoft Windows® Operating System environment, the various elements of embodiments of the present invention can be implemented in other operating system contexts, including, but not limited to, Apple Macintosh OS, Linux and Unix.

In one embodiment of the present invention, the stream server application (also referred to herein as “SS”) 106 executes as a regular user level application (such as a DLL) within the user context of the client application 104 and not as a system level “service”. As such, the stream server 106 has the same user access rights as the logged in user of the client application 104. Therefore the stream server 106 of embodiments of the present invention does not need to be set up by a system administrator or a user with elevated local system administration rights and has the same rights and access level to the content data and files of the image as the user that created the image. In another embodiment of the present invention the stream server application 106 executes as a separate process on the client computer 102, again typically within the user's context, allowing the client application to be terminated by the user if desired.

The stream server 106 starts by setting up a listening socket to accept connection requests. It is noted that embodiments of the present invention utilizing other network types and connection protocols, besides TCP/IP sockets are possible and will be apparent to those skilled in the art with the benefit of the present disclosure. When a connection request from a production server 110 is received, the SS 106 creates a new socket and thread to process the connection. The new thread then waits for and responds to a series of packets starting with the “Query File” packet as detailed in the Communication Format section below. There is no limit on the number of open connections or the number of production servers 110 that may connect, unless it is limited by the operating system of the client computer 102 or the stream server 106 and/or the production server 110 themselves. In addition, in one embodiment, the production servers 110 can also accept multiple connections from several different client computers 102 and their associated stream servers 106. Thus, it is noted that various embodiments of the present invention can allow for simultaneous one-to-many or many-to-many connectivity to occur.

The listening socket is set up using the first available port in a predetermined range of ports, in one embodiment ports 9613-9699. After the SS 106 finds this port, it publishes a message via a messaging API (or other interprocess communication protocol/interface), containing the following string properties: “hostname”, “port”, “logonld” (if SS 106 was started by the Enterprise Imaging Server (or EIS), this will be “RimageServices”), and an integer property named “isExtemal”, which is set to 1 if EIS started it, passing it the “-svc” parameter on the command-line. The stream server application 106 also sets up a listener for the “server.request.stream” topic in the messaging API and resends this information whenever a request on this topic arrives.

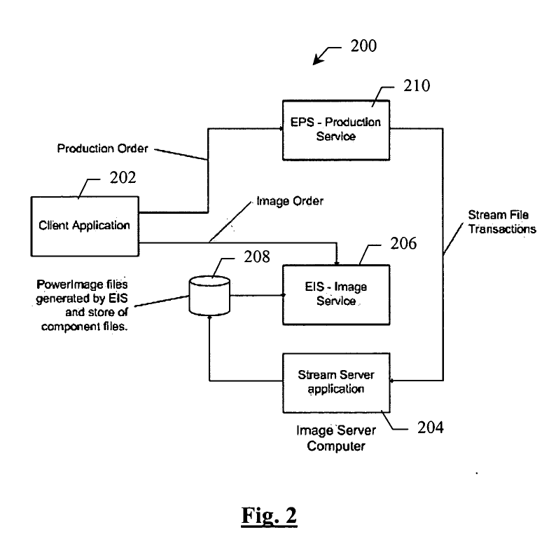

An Enterprise Imaging Server (or EIS) as used in the present application refers to an imaging service having particular properties that are more mass production oriented. In a situation in which EIS is used, an alternate system 200, shown in FIG. 2, is used. System 200 comprises a client application 202, a stream server application 204 on an image server computer, an image service (EIS) 206, a set of PowerImage files (or alternatively a full, partial, ISO, UDF, hybrid, multi-session, RAW, or audio image) generated by the EIS 206 (and a store of component files) 208, and a production server 210. The client application 202 provides an image order to the imaging service, which generates an image to be stored or provided at store 208. The stream server application 204 (which can be either a separate process or a DLL) streams files to the production server 210 based on a production order, containing the names of the files and/or images generated by EIS, sent to the production service by the client application 202.

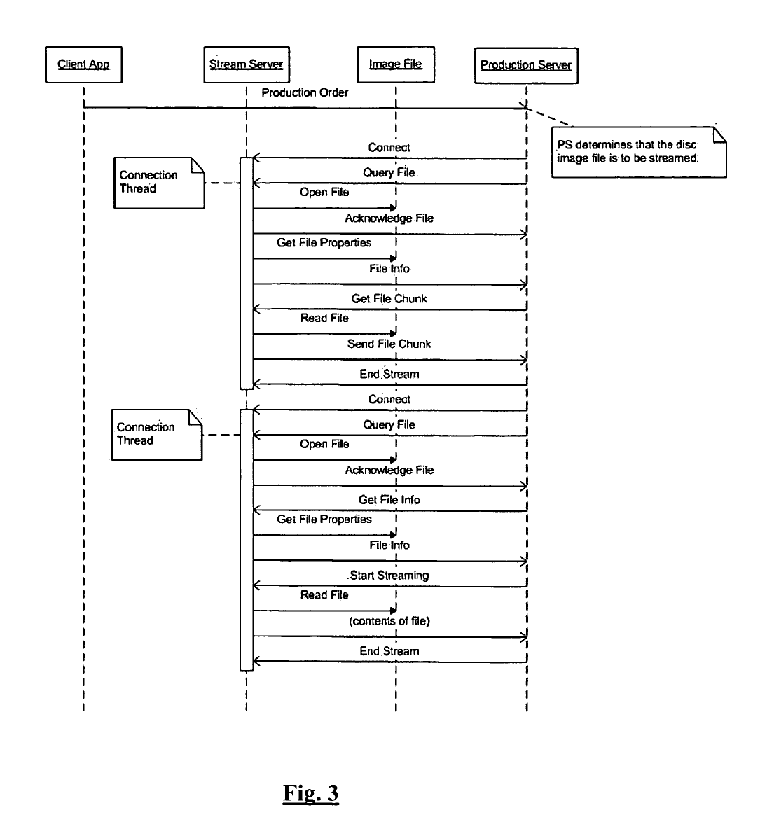

A method according to one embodiment of the present invention uses a client computer-based application on what is referred to as a remote computer. A user of the remote or client computer decides what the user wishes to be recorded by a production system. The client application assembles an image (which in various embodiments can be, but is not limited to, a partial image in need of expansion and processing, a PowerImage, an ISO image, a full expanded image, UDF image, hybrid image, multi-session image, RAW image, audio format image, or the like). The client application sends an order to the producer/production system, indicating to the producer that the client computer is ready to stream data, and how the data will be streamed. The order to the producer in one embodiment contains information sufficient for the producer to recognize a stream server application from the remote computer. The producer at that point starts transactions with the stream server application executing on the remote computer under a message flow protocol described in greater detail below, and with reference to FIG. 3. It is noted that embodiments of the present invention are format and media independent and can be utilized to produce multiple types of images, formats and forms of recordable media.

Referring now to FIG. 3, at the beginning of an order, if the production system (PS) determines that the image on the remote computer may be streamed, it connects to the ‘listening’ socket on the stream server-application (SS). It then sends the “Query File” message and waits for the “Acknowledge File” response. If the “Acknowledge File” response indicates that the file is available the PS sends the “Get File Info” packet and waits for the “File Info” response which contains the file size. The PS then sends one or more “Get File Chunk” messages to retrieve information about the image file, such as the block size. The PS then sends an End Stream command to terminate the connection after transfer of the information on the file is complete. Later, the PS opens another connection and sends the “Start Streaming” message to retrieve the file contents and again sends an End Stream command to terminate the connection after transfer is complete. More than one connection to the streaming server application may be opened for a single image if multiple recorders and/or production systems will be used to produce the order.

If another copy is to be recorded, the PS sends the “Start Streaming” message again and the SS starts sending the file from the start. When the PS is finished with the order, it sends the “End Stream” message to signal SS to close the socket.

It is noted that the message flow protocol described in FIG. 3 is for illustrative purposes and not to be taken as limiting and, further, that embodiments utilizing other protocols and formats are possible and will be apparent to those skilled in the art with the benefit of the present disclosure. It is also noted that other data besides files, data, and recordable media images may be transferred by embodiments of the present invention, including but not limited to recordable media cover art, liner notes, production metadata, security formats, specialized recordable media type selections for the production system, etc. In particular, this allows for other data that is associated with the image being recorded to also be transferred in the streaming operation.

A proprietary image format, known as PowerImage, owned by the assignee to the present application, has additional functionality when used with the embodiments of the present invention. If the file to be recorded at the PS is a PowerImage file, which is a form of partial image, then it is possible that some of the source files that make up the image have changed, deleted, or are open by another process. To handle the errors that can occur, the SS checks each file included in the PowerImage (or alternatively in a conventional partial image format) to see if the file size has changed since the partial image or PowerImage file was created or if it can be opened to get the data. If there is a problem or if the underlying file has been altered, the Stream Server stores the error information and closes the connection. After the PS times out on receiving data from the Stream Server it requests the error information using the Get PowerImage Error Info message described below.

Message types used in one embodiment of the present invention are described in greater detail below.

Type 1—Query File

PS sends this message to SS to see if the specified file is available to the Stream Server. The message data is a string containing the full path to the file specified in the Production Order. SS responds with the “Acknowledge File” message.

Type 2—Acknowledge File

SS sends this message to PS in response to the “Query File” packet. The message data is an array of characters. If the file could be opened by the stream server, the first and only character is a binary zero. If the file could not be found, the first and only character is a binary one. If the file could not be opened for another reason, the first character is a binary 2 and the rest of the characters are a string describing the error.

Type 3—Get File Info

PS sends this message to SS after “Acknowledge File” is received. This message has no data. SS responds with the “File Info” message.

Type 4—File Info

SS sends this message to PS in response to the “Get File Info” message. The data is the size of the file (in the case of a PowerImage file, the fully expanded size), sent as a 64-bit integer. Two additional 2-byte binary values are appended. The first value is 1 to indicate that it is a PowerImage file or 0 if not. If the file is a PowerImage image file the second 2-byte binary value is the block size.

Type 5—Get File Chunk

PS sends this message to SS to request a portion of the file. PS typically examines parts of a file to determine the block size of a non-PowerImage image file. This message is sent before the Start Streaming command. The message data in one embodiment is a 64-bit integer specifying the offset in the file and a 32-bit unsigned integer specifying the amount of data to send.

Type 6—Send File Chunk

SS sends this message to PS in response to the “Get File Chunk” message. The data in one embodiment is a 32-bit unsigned integer which is 0 if some or all of the data was read from the file successfully, 1 if SS failed to seek to the specified offset, or 2 otherwise. If the read was successful, the next 32-bit unsigned integer indicates the amount of data that was read from the file. The message length and checksum fields do not include the file data. This is followed by the file data.

Type 7—Start Streaming

PS sends this message to SS when it is ready to begin receiving the image. The message data is a string representing a connection ID. This is used to retrieve the error information in the case of a PowerImage expansion error. This packet can be sent multiple times if there is more than one copy to be made, the file is a track image, and caching is disabled on PS.

Type 8—Abort Streaming

PS sends this message to SS when there is a recording error and the stream represents a track image. SS should stop sending data to the socket when it receives this message. This message has no data. After sending this message, PS continues to receive data until the data written to the socket by the Stream Server has been emptied.

Type 9—Get PowerImage Error Info

PS sends this message to SS when the stream is interrupted while streaming a PowerImage file. The data in this packet in one embodiment is a string containing the same connection ID used in the Start Streaming message.

Type 10—Send PowerImage Error Info

SS sends this message to PS in response to the “Get PowerImage Error Info message. The data in this packet in one embodiment consists of four 32-bit unsigned integers representing the following values:

Failed flag—1 if there was a PowerImage expansion error, 0 otherwise.

Error code—value representing the error that occurred during the PowerImage expansion, 0 if there was no error.

File error code—the operating system error code if there was an error opening or reading a file.

Offset—the offset in the PowerImage file where the problem occurred.

There may also be an optional string containing the name of either the PowerImage file or the name of one of the component files that the error occurred with.

Type 11—End Stream

PS sends this packet to SS when it has no further use for the stream. SS closes its end of the socket and terminates the thread dedicated to it when it receives this packet. This packet has no data.

In prior art systems, production servers or production systems had to have system level (i.e., a “share” folder, mountable drive, or other system file transfer level) access rights (and not end-user level access rights) to the data on the client computer, since the production system directly accessed and dictated the flow of data outside of the context of the client application that created the recordable media image. In the present invention embodiments, there are no open share problems, as the client application and user context stream server executing on the client computer determines what data is sent and when, as opposed to the remote computer pulling the data. The data security allows a user to set permissions on what the remote computer can access, and when without the need to involve network administration. Further, the underlying data can be protected from the production system by the use of fully formed images or data files from partial images that are streamed to the production system, such that the production system does not have modification rights to the data or files on the client computer. The production server gets images via a protocol such as a TCP/IP connection. No direct access of the image file or the files that comprise the image file is required by the production server, and, as the data and files can be streamed on demand, the full data or underlying data files do not need to be cached locally on the production system during the recording process. This avoids the need to have multiple copies made of data and/or files to be written and network transfers of the images and/or data only occur during recording. As such, embodiments of the present invention efficiently handle large data sets for recording, increasing recording and network performance and decreasing cost and hardware footprint. In particular, in embodiments of the present invention that utilize partial image or PowerImage formats, the client computer does not need to create the actual full recordable media image. It is assembled as part of the streaming operation from the streaming server to the production server and, once fully or partially assembled at the production server, recorded or not, as desired, on to the recordable media. It is noted, however, that local caching of images, data, and data files can occur in other various embodiments of the present invention where it is advantageous for operations such as large production runs of recordable media having multiple copies of the same image, or where subsequent images are highly similar in content, such that only the changes between image recordings need to be re-streamed to the production system.

Because of the data streaming, reduced file/data access requirements, and security/administration needs of embodiments of the present invention production hardware can be simplified by the elimination or reduction of local cache and easing of production system upgrades and new media types. In addition, the recordable media production process made is more efficient, and configuration and administration overhead is reduced. Further, possible new business models can be utilized, including, but not limited to just-in-time media production, limited promotional media runs, online end user customized and/or selected media, and production-less content creation, such as “indie” content providers utilizing an independent media producer/packaging house by connection through the internet and firewalls that would block normal share or file transfer operations.

The embodiments of the present invention provide methods and apparatus for sending content to be recorded directly to a remote production server while allowing the limiting of the amount of access the remote server has to the underlying files and content. This is accomplished by providing a stream of data from the client location computer through a stream server application. The stream server application has access to the underlying files and content, and streams the content on its own initiation after a request from the production server, not on the initiation of the production server. The content in one embodiment is streamed directly to a recorder of the production server, without requiring a cache on the production server or reducing the cache dependence to only having enough data on hand to support and smooth the data streaming and recording process. This reduces the amount of hardware required for the production server, eases system upgrades and changes in recordable media, as well as reduces the likelihood of failures since fewer components are involved. Further, time is saved as a separate writing of content to a cache is eliminated.

In some embodiments, however, it is desirable to write to a cache. Such embodiments include situations where the content of the image may change slightly for different recordings, but the majority of information remains the same. For example, in the case of a PowerImage file (described above), the streaming process can send the image to the production server for storage in cache, or on a hard drive of the production server. The production server can be sent small changes to be integrated with the cached or stored image, allowing user modification on the fly.

It is noted that the software routines and drivers, such as various embodiments of the present invention, that operate computer based devices are often stored on machine-usable storage devices until they are read and executed. It is also noted that a variety of computer readable or machine-usable storage mediums are commonly utilized including, but not limited to, a non-volatile Flash memory, a ROM, an EEPROM, an application specific integrated circuit (ASIC), a magnetic media disk, a CD-ROM, a DVD, a hard drive, etc.

### CONCLUSION

A method and apparatus for streaming of data from a remote computer to a recordable media production system has been described that utilizes a client computer based application that reduces or eliminates the need for caching of data at the production system, as well as increases security and reliability. This is accomplished in the various embodiments with a client computer application that is run at the user level reducing system complexity and the need for system administrator involvement and oversight. The application pushes data to a production system “on the fly” without requiring a cache or extra disk space.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only the claims and the equivalents thereof.

What is claimed:

1. A method of streaming, comprising:
assembling an image of a recordable media at a first computer containing information to be recorded on the recordable media at a remote computer;
initiating communication with the remote computer through a client application on the first computer;
sending an order to the remote computer to produce a recording of the image on the recordable media; and
streaming the image directly to the recorder of the remote computer without using a cache of the remote computer.

2. The method of claim 1, wherein the image is one of a partial image, a PowerImage, an ISO image, a UDF image, a hybrid image, a multi-session image, a RAW image, an audio format image, and a full image.

3. The method of claim 1, wherein the recordable media is one of a magnetic media, an optical media, and a solid-state media.

4. The method of claim 3, wherein the recordable media is one of a floppy disk, a tape, a hard drive disk, a CD-ROM, a DVD, a Blue-Ray DVD, a Magneto-Optical disk, a Holographic disk, a Flash memory device and a PROM memory device.

5. The method of claim 1, wherein a streaming server streams the image to the recorder of the remote computer and executes with the same user privileges as the client application.

6. The method of claim 5, wherein the streaming server is a separate process or DLL executing on the first computer.

7. The method of claim 1, further comprising caching one or more select data or files of the image locally on the remote computer for production of a second image on recordable media.

8. The method of claim 1, further comprising streaming a second image to a second remote computer to produce a recording of the second image on a second recordable media from the first computer.

9. The method of claim 1, further comprising streaming a second image of a recordable media from a second computer and second client application to the remote computer.

10. The method of claim 1, further comprising streaming one of recordable media cover art, liner notes, production metadata, security formats, and specialized recordable media type selection data to the remote computer.

11. A computer readable medium, the computer readable medium containing a software routine for causing a processor to execute a method, wherein the method comprises:
initiating communication with a recordable media producer system through an application on a first computer;
sending an order to the recordable media producer system to produce a recording of a media image on a recordable media; and
streaming the media image directly to the recordable media producer system without caching the media image on the recordable media producer system.

12. The computer readable medium of claim 11, wherein the media image is one of a partial image, a PowerImage, an ISO image, a UDF image, a hybrid image, a multi-session image, a RAW image, an audio format image, and a full image.

13. The computer readable medium of claim 11, wherein the recordable media is one of a magnetic media, an optical media, and a solid-state media.

14. The computer readable medium of claim 11, wherein a streaming server streams the image to the recordable media producer system and executes as an independent process on the first computer with user-level privileges.

15. The computer readable medium of claim 11, further comprising caching one or more select data or files of the image locally on the recordable media producer system.

16. The computer readable medium of claim 11, further comprising streaming one of recordable media cover art, liner notes, production metadata, security formats, and specialized recordable media type selection data to the recordable media producer system.

17. A method of streaming content to a remote recorder from a client computer, comprising:
producing an image of the content on the client computer; and
pushing the content to the remote computer without caching the content at the remote recorder.

18. The method of claim 17, wherein the image is one of a partial image, a PowerImage, an ISO image, a UDF image, a hybrid image, a multi-session image, a RAW image, an audio format image, and a full expanded image.

19. The method of claim 17, wherein a streaming server on the client computer pushes the image to the recorder of the remote computer and executes with the same privileges as a user of the client computer.

20. The method of claim 19, wherein the streaming server is a separate process or DLL executing on the client computer.

21. The method of claim 17, further comprising pushing one of a recordable media cover, a liner note, a production metadata, a security format, and a specialized recordable media type selection data to the remote computer.

22. A system, comprising:
a production server;
one or more client computers, each connectable to the production server to send a production order for a recordable media to the production server, each client computer operating a client application and a stream server application adapted to perform a method comprising:
assembling an image of the recordable media at its client computer of information to be recorded at the production server;
initiating communication with the production server;
sending an order to the production server to produce a recording of the image on recordable media; and
streaming the image directly to a recorder of the production server without using a cache of the production server.

23. The system of claim 22, wherein the image is one of a partial image, a PowerImage, an ISO image, a UDF image, a hybrid image, a multi-session image, a RAW image, an audio format image, and a full image.

24. The system of claim 22, wherein the streaming server streams the image of the recordable media to the production server.

25. The system of claim 24, wherein the streaming server is a separate process or a DLL hosted by the client application executing with user-level privileges on each client computer.

26. The system of claim 22, further comprising selecting one or more select data or files of the image to cache locally on the production server to record a second copy of the image on recordable media or for utilization in recording different image on recordable media.

27. The system of claim 22, further comprising streaming one of recordable media cover art, liner notes, production metadata, security formats, and specialized recordable media type selection data associated with the image to the production server.

28. A recordable media producer system, comprising:
a recorder;
a controller; wherein the controller is connectable to a network and adapted to process a production order to record an image on a recordable media by:
receiving an order from a client application executing on a remote client computer to produce a recording of the image on recordable media; and
initiating a connection across a network to stream the image directly to the recorder without using a cache.
